(19) United States
(12) Patent Application Publication
(10) Pub. No.: US 2009/0255175 A1
(43) Pub. Date: Oct. 15, 2009

(54) Kiss cut tree ties

(76) Inventors: Joe Fitzgerald, Apple Valley, CA (US); Rosendo Guerrero, Duarte, CA (US)

Correspondence Address: LAW OFFICES OF CLEMENT CHENG, 17220 NEWHOPE STREET #127, FOUNTAIN VALLEY, CA, 92708, US

(21) Appl. No.: 12/082,613

(22) Filed: Apr. 11, 2008

(51) Int. Cl. A01G 17/12

(52) U.S. Cl. 47/43

(57) ABSTRACT

Pairs of tree ties are made from a section of flexible tube, each comprising a shorter tube head section at one end and a longer half tube tail extending from the tube head section and terminating at a threading tip at the opposite end of the tail for making a self tie loop through the tube head section for securely holding a tree to a support. Two parallel units in a tree tie pair are temporarily joined along a score line in a diametrically opposite orientation with respect to each other, wherein a cycle of die cutting forms a kiss cut that creates the score line and a separation indenture between a leading tree tie pair and a trailing tree tie pair.

### BACKGROUND OF THE INVENTION

A. Field of the Invention

The present invention relates to tree ties. More particularly, the present invention relates to continuous supply of complete tubular tree ties that are instantly harvested from a length of rubber or plastic hose by preliminary kiss-cuts leaving no wastes.

B. Description of the Prior Art

For the healthy growth of young trees, it is necessary to support them for a period of time normally with the help of stakes or posts. Tree ties have been developed to provide an ideal connection between the trees and posts preferably with an enough yield to allow continued growth of the tree trunk and a flexibility to absorb environmental forces before breaking the tie. It is also desirable to have the tree ties adjusted in tightness as the tree girth expands.

In order to meet these and other requirements, different materials and complex designs have been combined to get better tree ties. U.S. Pat. No. 4,222,198 to Napolitano et al. suggests a sophisticated tree tie having a collar over two tie lines under a spring bias held in the collar. Otherwise, a length of metal wire was simply covered with shorter rubber hose to prevent damage to the tree.

Variations from a conventional plastic cable tie consist of a molded flexible strap with a keyhole head and a number of locking nodes located at even intervals on the strap so that the strap forms a releasable self-locking loop about a tree and post.

In order to attain a real impact on speed and cost reduction in tree planting and maintenance, further advancement in tree tie structure and manufacture is necessary.

### SUMMARY OF THE INVENTION

In view of the foregoing, an object of the present invention is to provide super simple but effective tree ties in a row by repeated kiss-cuts on a length of flexible tube that can be easily handled in manufacture as well as in the field applications.

Another object of the present invention is to provide a tree tie structure having an intuitively easy self-locking means integrated into a singular tie body harvested from a precut tubular supply.

Yet another object of the invention is to provide tree ties that are made from already available tube material just through kiss-cuts.

According to the present invention, there are provided multiple tree ties preformed in a single flexible tube for holding a tree to a nearby support. The flexible tube comprises a series of kiss cuts for defining continuous identical pairs of tree tie patterns along generally axial contoured lines on the tube and intermittent separation score marks extending transversely of the tube between leading pairs of the tree tie patterns and trailing pairs of the tree tie patterns. Upon separation at the preformed patterns each unit of the tree ties out of the respective pairs assumes a tubular loop head provided with a front end defined by the separation score marks, a rear end section located at a close distance from the front end of the loop head, and an elongated half-tube section merged in the rear end section of the loop head and terminating at a threading end in a complementary shape to the rear end section of the loop head of the oppositely formed unit of the tree ties in a pair. The threading end of each unit tree tie is inserted in the loop head of the same tree tie in bilateral axial directions in order to make an instant and firm tie knot about the tree and support.

The tubular material may be made of rubber or plastic. The tree ties may be preformed in an extended length of the flexible tube, which is conveniently transported on a spool.

The front end of the loop head may extend obliquely with respect to the axial extension of the tube. The preformed tree ties may be separated by light manual forces. The threading end of the elongated half-tube section of the unit tree tie may be in the shape of a round protruding beak for an easy insertion into the loop head of the same unit tree tie.

Two or more unit tree ties may be joined together by coupling the threading end of one unit tree tie to the loop head of the next unit tree tie in order to prolong the half-tube section to work on a bigger tree.

The multiple kiss cuts may be made through rotary die cuts wherein a roller wheel is coupled with a blade wheel to maintain a predetermined space between the wheels through which the tube material is pulled as it receives the rotary die blade cuts. The blade wheel is adjustable in distance to the blade wheel to provide controlled space volumes adaptable to different dimensions of the tube. So, a thick or thin walled tube may be readily processed to provide the equally improved tree ties of the present invention.

Embodiments of the invention will now be described by way of example with reference to the accompanying drawings.

### BRIEF DESCRIPTION OF THE DRAWINGS

FIG. 1 is a perspective view of the tree ties by kiss-cuts according to the present invention.

FIG. 2 is a front view of the tree ties formed between a pair of kiss-cut rollers in according to one embodiment of the invention.

FIG. 3 is a rear view of the upper roller having die blades for executing the kiss-cuts.

FIG. 4 is an enlarged cross sectional view of FIG. 2 at encircled portion 4 showing the kiss-cut in detail.

FIG. 5 is a partial side view of the upper die blades to show blade gaps and recesses to provide temporary connections between the unit tree ties supplied in a coil form.

FIG. 6 is a perspective view of a pair of identical tree ties in opposite orientations broken off the processed tube to show the lines for separating unit tree ties from each other for application.

FIG. 7 is a side elevational view of tree ties in the process of die cutting having the finished tree ties partially twisted to reveal the internal lower score lines with two reinforcement points.

FIG. 8 is a plan view of a finished section of the multiple tree ties showing the upper thru cuts for defining each unit tree ties.

FIG. 9 is a perspective view of a supply of connected tree ties in coil form ready to deploy from a convenient spool.

FIG. 10 is a side elevational view of a unit tree tie in a loop assuming an exemplary tie knot for securing positions of trees for support.

Similar reference numbers denote corresponding features throughout the attached drawings.

| | | | | | |
|---|---|---|---|---|---|
| 8: | Tube head section | 10: | Multiple tree ties | 11: | Tree tie pair |
| 12: | Unit tree tie | 14: | Rotary die station | 16: | Blade wheel |
| 18, 20: | End rim | 22: | Blades pattern | 24: | Peripheral recess |
| 26, 27: | Shaft | 30: | Tube | 32: | Circular blade |
| 33: | Break | 34: | Main kiss cut | 36: | Transverse blade |
| 37: | Gap | 38: | Separation Indenture | 39: | Front end |
| 40: | Curved end | 42: | Half tube section, Tail | 44: | Rear end section |
| 46: | Threading tip | 48: | Curvature | 50: | Upper thru cut |
| 52: | Lower kiss cut | 54: | Short incision | 56: | Recess |
| 58: | Coil form | 60: | Trace | 62: | Spool |
| 64: | Tie loop | 66: | Fold | | |

### DETAILED DESCRIPTION OF THE PREFERRED EMBODIMENT

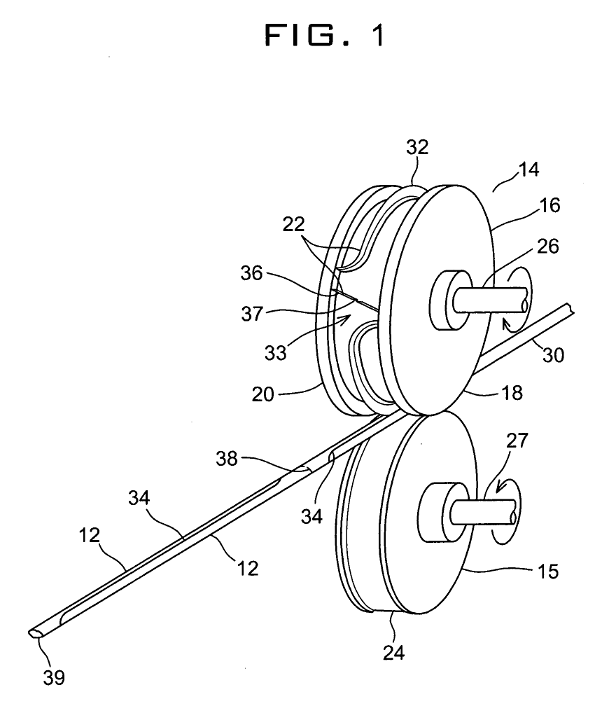

With reference to FIG. 1, multiple tree ties 10 of the present invention are implemented on a simple flexible tube 30 of selected diameter and wall thickness under a die cutting process as it advances through a rotary die station 14 including a supporting roller wheel 15 and a blade wheel 16. Tube 30 may be selected from any currently available flex tube material, which is of rubber, soft plastic or other synthetic material. The rotary die station 14 and the supporting roller wheel 15 are preferably motorized so that they have equal rotational movement and radius. Thus, supporting roller wheel 15 preferably has a gripping surface, but can also be made with a stainless steel surface touching the tube being cut.

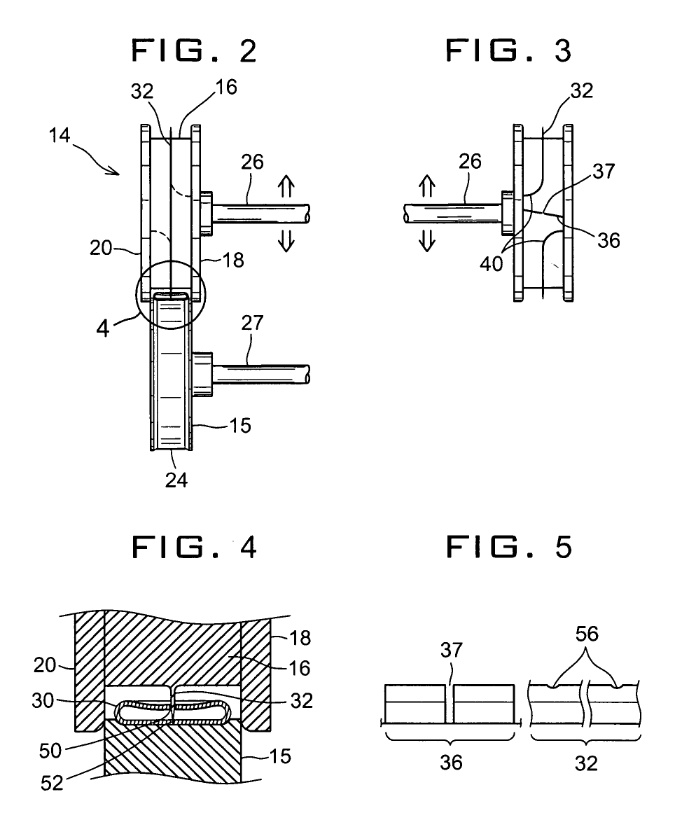

Also referring to FIG. 2, blade wheel 16 has a predetermined circumference such as 30 inches coinciding the length of a unit tree tie 12 and spans for example ¾ inches in width bordered by opposite end rims 18 and 20. By having a larger diameter of blade wheel 16 longer tree ties 12 may be made. By having the end rims 18, 20 with various internal distances between them, the effective width of blade wheel 16 may be made adjustable to adapt to different tube substrates. Between the rims 18, 20 is a pattern of circumferential blades 22 with gaps and recesses, which will be described below. When the flex tube 30 passes a severing pressure under blades 22 between wheels 15, 16 it temporarily becomes flat and laterally extends close to half of its circumference. Therefore, the above-specified ¾ inches of wheel span may be increased or decreased in consideration of the deformed dimension of the selected tube substrate 30. To align tube 30 with blades 22, roller wheel 15 may have a peripheral recess 24 for centering tube 30 as it is fed through the die station 14.

The roller wheel 15 and blade wheel 16 may be independently driven by shafts 26 and 27 connected to a single driving means (not shown) to provide precision timed but opposite rotations with respect to each other. In order to accept various dimensions of flex tube 30 as a substrate to make the tree ties 10, blade wheel 16 is made adjustable in distance with respect to roller wheel 15. Blades 22 mainly comprise a circular blade 32 with a break 33 to impart a series of separated principal kiss-cuts 34 generally shaped like the integral symbol ‘∫’ or its inversion into flex tube 30 and a transverse blade 36 with an intermediate gap 37 to form a separation indenture 38 between two consecutive tree ties 12. As shown in FIG. 3, the separation blade 36 is slanted with reference to shaft 26 to form an oblique cut in tube 30, Thus, single execution of transverse blade 36 will simultaneously form oblique front ends 39 of the two consecutive tree ties 10. The best mode is to have one rotation of the blade wheel 16 make a single cut to form a pair of tree ties 12, however the blade wheel 16 can also be enlarged so that two or more pairs of tree ties 12 can be formed with a single rotation of the blade wheel 16.

Turning to FIG. 6, a pair 11 of unit tree ties 12 is consisted of two parallel units of the tree ties being temporarily joined along a score line 52 in a diametrically opposite orientation with respect to each other. Therefore, the tree tie pair 11 is made from a section of flexible tube, each comprising a shorter tube head section 8 at one end and a longer half tube tail 42 extending from the tube head section 8 and terminating at a threading tip 46 at the opposite end of the tail 42 for making a self tie loop through the tube head section 8 for securely holding a tree to a support. Two parallel units in a tree tie pair 11 are temporarily joined along a score line 52 in a diametrically opposite orientation with respect to each other. And a separation indenture between a leading tree tie pair and a trailing tree tie pair forms oblique front ends 39 of two proximal tree ties 12.

To this end, the blade 32 at break 33 has two outwardly curved ends 40 close to each other that completes two extended half tube sections 42 with respective rear end sections 44 merged with half tube section 42 in the same unit tree tie 12 and threading ends 46 extending from rear end section 44 all the way through half tube section 42. Due to the cutting scheme to produce the tree tie pair 11 per unit tube length according to the present invention, rear end sections 44 and threading ends 46 will have round edges of a common curvature 48.

In order to make the multiple tree ties 10 of the present invention more convenient to handle during transport and field applications, tree ties 10 may be entirely made from a continued length of tube 30 with kiss-cuts so that they are kept connected in a tube form that can be wound around a carrier until each unit tree tie 12 is harvested by tearing off the tree tie coil. The kiss cuts for defining the detachable multiple tree ties 10 are designed so that deployment of the entire unit tree ties leaves no waste of the substrate of flex tube 30. The kiss cuts sometimes protrude all the way through, and at other times barely scathe the surface being cut.

FIG. 4 shows in greater detail kiss cut 34 into flex tube 30 having an upper thru cut 50 formed in the upper side of two substantially overlapping walls of the flattened tube 30 by a lower level section of the rotationally penetrating circular blade 32. The kiss cut 30 also has a lower kiss cut 52 short of penetrating the lower side of overlapping walls of tube 30. The position of blade wheel 16 with respect to roller wheel 15 may be adjusted to keep the lower kiss cut 52 easy to break manually as well as the integrity of the multiple tree ties 10 until application. Thus, the contoured kiss cuts are provided except where localized reinforcements are desired to resist inadvertent separations of the unit tree ties during transport thereof in a coil form. The lower kiss cut 54 is cut less than the upper through cut 50.

Such reinforcements are made by discrete gaps or recesses formed on blades 32 and 36 as shown in FIG. 5. Gap 37 in the middle of transverse blade 36 may extend throughout the height of blade 36 to make separation indenture 38 on tube 30 with diametrically opposite middle breaks that correspond to gap 37 forming a convenient tear line between a leading tree tie pair and a trailing pair. On top of the lower kiss cut 52, circular blade 32 may simultaneously provide a number of short incisions 54 shown in FIG. 6. Incisions 54 are formed by recesses 56, two of which may be located at even interval along the blade 32 in order to create reinforced kiss cut points equally spaced from both forward ends 39 in the tree tie pair 12-12. Incisions 54 support the integrity of connected multiple tree tie coils 10 but permit an easy manual breaking of unit tree ties 12 from a coil form 58 (see FIG. 9).

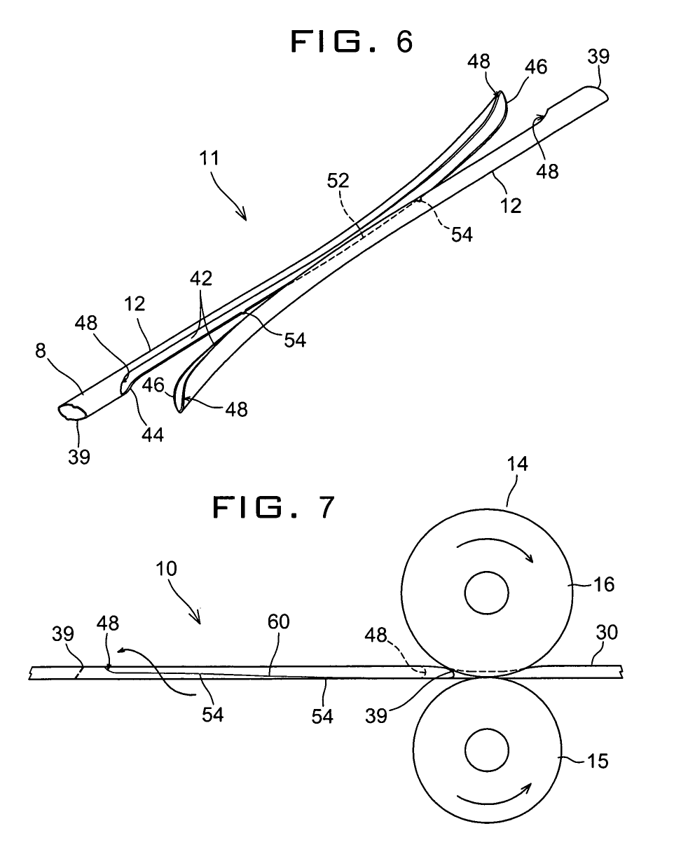

FIG. 7 illustrates the continuous die cutting of tube 30 to produce the kiss cut tree ties still in a unit body of tube 30 with multiple score lines formed only through a single process at die station 14. Finished tree ties 10 are gradually twisted to reveal lower kiss cuts 52 that may be detectable through a trace 60 of the score lines.

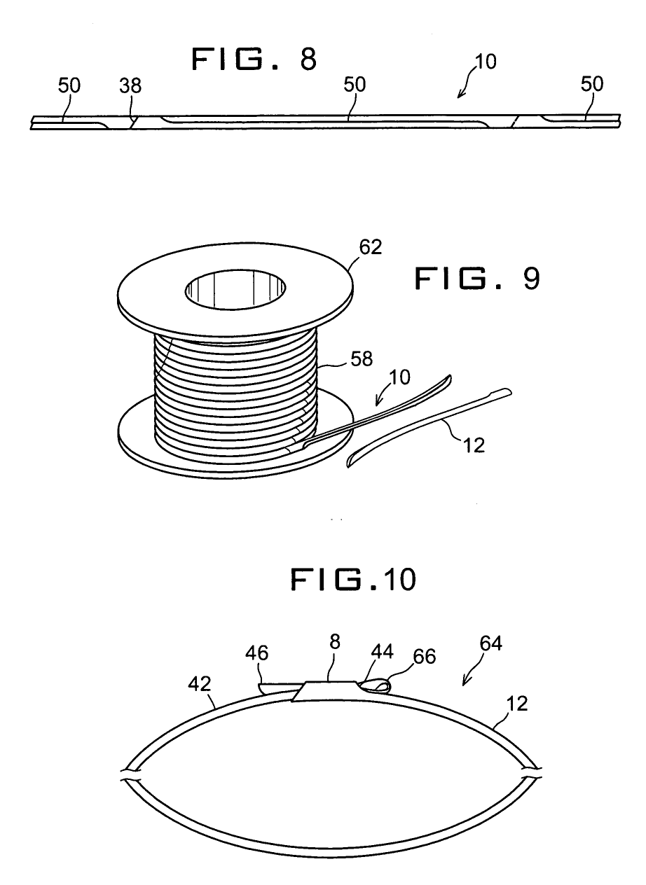

FIG. 8 is a plan view of the finished multiple tree ties 10 showing the upper thru cuts 50 for determining each unit tree ties and separation indentures 38 for dividing a pair of tree ties from the next pair. FIG. 9 is a perspective view of a supply of connected tree ties in coil form 58 ready to deploy from a convenient spool 62.

FIG. 10 shows an example of how a tie loop 64 may be made using the tree tie 12 manufactured as above. Tube head section 8 is holding a double thread of threading tip 46 secured by an expanded fold 66 stopped at rear end section 44. By manufacturing different lengths of the tree ties 12 or by joining a number of shorter ties 12 through an instant connection between tube head section 8 of one tie 12 and tube tail 42 of another tie, it is possible to make an enlarged loop to suit different trunk sizes of bigger and smaller trees.

For assembly, the ties are preferably wrapped around a cardboard structure spool 62. The spool can receive a string of ties of a very very long length since all of the connected tree ties are in coil form 58. The spool 62 can therefore be of any practical dimension. The user may place a hand or arm through the center portion of the spool. The user can then tear away tree ties as needed. Optionally, the spool can be put on a dispenser arm so that a user can tear off tree ties as needed, similar to tearing off sheets of paper towels as needed from a paper towel roll.

Therefore, while the presently preferred form of the tree ties by kiss cuts has been shown and described, and several modifications thereof discussed, persons skilled in this art will readily appreciate that various additional changes and modifications may be made without departing from the spirit of the invention, as defined and differentiated by the following claims.

1. Kiss cut tree ties comprising: a string of tree ties having kiss cuts preformed from a single flexible tube for holding a tree to a nearby support, the flexible tube comprising a series of kiss cuts for defining continuous identical pairs of tree tie patterns along generally axial contoured lines on the tube and intermittent separation score marks extending transversely of the tube between leading pairs of the tree tie patterns and trailing pairs of the tree tie patterns, wherein upon separation at the preformed patterns each unit of the tree ties out of the respective pairs assumes a tubular loop head provided with a front end defined by the separation score marks, a rear end section located at a close distance from the front end of the loop head, and an elongated half-tube section merged in the rear end section of the loop head and terminating at a threading end in a complementary shape to the rear end section of the loop head of the oppositely formed unit of the tree ties in a pair, the threading end of each unit tree tie being inserted in the loop head of the same tree tie in bilateral axial directions in order to make an instant and firm tie knot about the tree and support.

2. The kiss cut tree ties of claim 1, wherein the tubular material is made of rubber.

3. The kiss cut tree ties of claim 1, wherein the tubular material is made of plastic.

4. The kiss cut tree ties of claim 1, wherein the tree ties are preformed in an extended length of the flexible tube, which is conveniently transported on a spool.

5. The kiss cut tree ties of claim 1, wherein the front end of the loop head extends obliquely with respect to the axial extension of the tube.

6. The kiss cut tree ties of claim 1, wherein the preformed tree ties are separated by light manual forces on their kiss cuts.

7. The kiss cut tree ties of claim 1, wherein the threading end of the elongated half-tube section of the unit tree tie is in the shape of a round protruding beak for an easy insertion into the loop head of the same unit tree tie.

8. The kiss cut tree ties of claim 1, wherein two or more unit tree ties are joined together by coupling the threading end of one unit tree tie to the loop head of the next unit tree tie in order to prolong the half-tube section to work on a bigger tree.

9. The kiss cut tree ties of claim 1, wherein the multiple kiss cuts are made through rotary die cuts.

10. The kiss cut tree ties of claim 9, wherein a roller wheel coupled with a blade wheel provides rotary die cuts in a predetermined space between the wheels.

11. The kiss cut tree ties of claim 10, wherein the blade wheel is adjustable in distance to the blade wheel to provide controlled space volumes adaptable to different dimensions of the tube.

12. Kiss cut tree ties comprising: pairs of tree ties made from a section of flexible tube, each comprising a shorter tube head section at one end and a longer half tube tail extending from the tube head section and terminating at a threading tip at the opposite end of the tail for making a self tie loop through the tube head section for securely holding a tree to a support, two parallel units of the tree ties being temporarily joined along a score line in a diametrically opposite orientation with respect to each other, wherein a cycle of die cutting forms a kiss cut that creates the score line and a separation indenture between a leading tree tie pair and a trailing tree tie pair.

13. The kiss cut tree ties of claim 12, wherein the flexible tube is made of rubber.

14. The kiss cut tree ties of claim 12, wherein the flexible tube is made of plastic.

15. The kiss cut tree ties of claim 12, wherein the tree ties are preformed in an extended length of the flexible tube, which is conveniently transported on a spool.

16. The kiss cut tree ties of claim 12, wherein the end of the tube head section extends obliquely with respect to the axial extension of the tube.

17. The kiss cut tree ties of claim 12, wherein the preformed tree ties are separated by light manual forces.

18. The kiss cut tree ties of claim 12, wherein the threading tip of the tube tail is in the shape of a round protruding beak for an easy insertion into the tube head section of the same unit tree tie.

19. The kiss cut tree ties of claim 12, wherein two or more unit tree ties are joined together by coupling the threading tip of one unit tree tie to the tube head section of the next unit tree tie in order to prolong the half-tube section to loop around on a bigger tree.

20. The kiss cut tree ties of claim 12, wherein the kiss cut is made through rotary die cuttting.
